(19) United States
(12) Patent Application Publication
(10) Pub. No.: US 2026/0051518 A1
(43) Pub. Date: Feb. 19, 2026

(54) PRESSURIZED FUEL CELL SYSTEM

(71) Applicant: Joby Aero, Inc., Santa Cruz, CA (US)

(72) Inventors: Michael Patrick Tucker, Palo Alto, CA (US); Jeffrey Allen Lotterman, Los Angeles, CA (US)

(21) Appl. No.: 19/297,584

(22) Filed: Aug. 12, 2025

Related U.S. Application Data
(60) Provisional application No. 63/682,526, filed on Aug. 13, 2024.

(51) Int. Cl. H01M 8/04089; B64D 27/355; B64D 31/16; H01M 8/04082; H01M 8/04111; H01M 8/04223; H01M 8/0444; H01M 8/04746

(52) U.S. Cl. CPC H01M 8/04104; B64D 27/355; B64D 31/16; H01M 8/04111; H01M 8/04201; H01M 8/04231; H01M 8/04447; H01M 8/04753; H01M 2220/20

(57) ABSTRACT

An aircraft fuel cell system includes a pressure vessel, a fuel cell stack located in the pressure vessel, a source of compressed air, and a valve to supply compressed air from the source of compressed air into the pressure vessel. Also included in the pressure vessel may be a coolant reservoir for a coolant loop for the fuel cell stack, as well as power electronics for the aircraft. A control system may purge the pressure vessel via a vent coupled to an external environment if an unacceptable level of hydrogen in the pressure vessel is reported by the hydrogen level sensor.

### RELATED APPLICATION DATA

This application claims the benefit of U.S. Provisional Patent Application No. 63/682,526 filed on Aug. 13, 2024, the content of which is incorporated in its entirety by this reference.

### TECHNICAL FIELD

This disclosure relates generally to the field of fuel cells fueled by hydrogen, including, for example, for use in electrically-powered or hybrid-powered aircraft.

### BACKGROUND

Fuel cell vehicles are powered by feeding hydrogen gas and air into an onboard fuel cell “stack,” which transforms the hydrogen's chemical energy into electrical energy. This electricity is then available to power the vehicle and its onboard systems.

Hydrogen supplied to a fuel cell comes into contact with a catalyst that promotes the separation of hydrogen atoms into an electron and proton. The electrons are gathered by a conductive current collector, which is connected to the vehicle's high-voltage circuitry, feeding an onboard battery and/or electric motors that propel the vehicle. The byproduct of the reaction occurring in the fuel cell stack is water vapor, which is emitted through an exhaust.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a plan view of an aircraft according to some examples.

FIG. 2 is a schematic view of an aircraft energy system according to some examples.

FIG. 3 is a schematic diagram illustrating a hydrogen and air supply system for use in supplying a stack module of the fuel cell stack of the aircraft of FIG. 1, according to some examples.

FIG. 4 is a schematic diagram illustrating a stack module of the fuel cell stack of the aircraft of FIG. 1, according to some examples.

FIG. 5 is a flowchart illustrating operation of the energy supply system of FIG. 2 and FIG. 3, according to some examples.

FIG. 6 illustrates a diagrammatic representation of a machine in the form of a computer system within which a set of instructions may be executed for causing the machine to perform any one or more of the methodologies discussed herein, according to some examples.

### DETAILED DESCRIPTION

The following description of examples of the invention is not intended to limit the invention to these examples, but rather to enable any person skilled in the art to make and use this invention.

Hydrogen fuel cell systems for aviation are typically segregated from other regions such as cargo or passenger compartments, for safety. If there is any problem with hydrogen leakage in the fuel cell system, it is separate from ignition sources that might be located elsewhere in the aircraft, and leaked hydrogen can be diluted to below flammable levels by ventilating the “hydrogen zone” containing the fuel cell system.

Fuel cells, having hundreds of internal layers, are also susceptible to differential pressures within the fuel cell and between the interior and exterior of the fuel cell. While fuel cell stacks are contained in an enclosure, they typically leak small amounts of hydrogen. Low ambient pressures at high altitude or pressure changes resulting from altitude changes can result in negative effects, both from the perspective of an overall gage pressure experienced by a fuel cell stack, as well as by inducing differential pressures within the fuel cell stack.

Furthermore, the electrical properties of air change with increasing altitude. In particular, air's ability to serve as an electrical insulator decreases with decreasing pressure, which forces design choices to be made that are less than optimal. Electrical components used at low altitude may not work at high altitude, or may be less safe. For example, gaps between conductors or components having different voltages need to be larger to prevent arcing at higher altitudes, requiring custom designs forced by high altitude considerations.

Finally, a cooling system for a fuel cell stack typically includes a coolant reservoir, which has to be able to accommodate coolant expansion and contraction during different operating and storage conditions, as well as dispensing coolant as needed. Low ambient pressures at altitude can result in coolant boiling in the coolant system at a lower temperature than would be the case on the ground.

To address one or more of these issues, components of the fuel cell system are enclosed in one or more pressure vessels. The pressure in the pressure vessel(s) is maintained at a pressure that is sufficient to overcome one or more of the problems mentioned above. In some examples, the pressure is maintained at or near a ground-level air pressure. The pressure in the pressure vessel(s) can be maintained in some examples by bleeding some of the air that has been compressed for use by the fuel cell into the pressure vessel. In other examples, the pressure in the pressure vessel can be maintained by one or more purge valves that relieve pressure over and above that which is required in the pressure vessel.

The following description of examples of the invention is not intended to limit the invention to these examples, but rather to enable any person skilled in the art to make and use this invention.

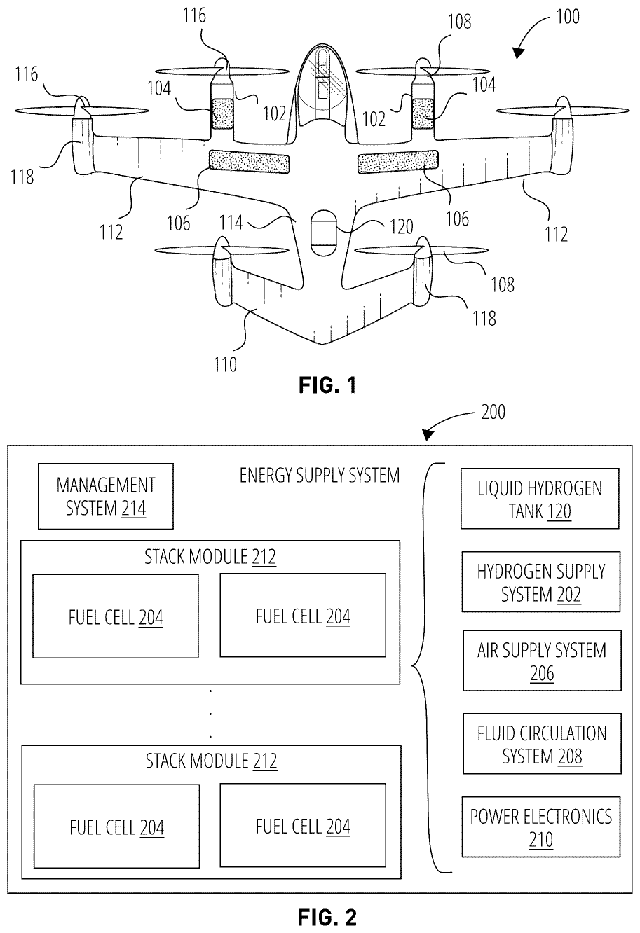

FIG. 1 is a plan view of an aircraft 100 according to some examples. The aircraft 100 includes a fuselage 114, two wings 112, an empennage 110 and propulsion systems 108 embodied as tiltable rotor assemblies 116 located in nacelles 118, 102. The aircraft 100 includes one or more fuel cell stacks, in some examples embodied as nacelle fuel cell stacks 104 and wing fuel cell stacks 106, which are supplied with hydrogen from a liquid hydrogen tank 120. The aircraft 100 will typically include associated equipment such as an electronic infrastructure, control surfaces, a cooling system, landing gear and so forth.

The wings 112 function to generate lift to support the aircraft 100 during forward flight. The wings 112 can additionally or alternately function to structurally support the fuel cell stacks 104, 106 and/or propulsion systems 108 under the influence of various structural stresses (e.g., acrodynamic forces, gravitational forces, propulsive forces, external point loads, distributed loads, and/or body forces, and so forth).

FIG. 2 is a schematic view of an aircraft energy supply system 200 according to some examples. As shown, the energy supply system 200 includes one or more stack modules 212. Each stack module 212 includes one or more fuel cells 204.

Typically associated with the one or more stack modules 212 are a source of hydrogen such as a liquid hydrogen tank 120, a hydrogen supply system 202 for supplying hydrogen to the stack modules 212 and for dealing with byproducts, an air supply system 206 for supplying air to the stack modules 212 and for dealing with fuel cell exhaust, a fluid circulation system 208 for transferring heat, and power electronics 210 for regulating delivery of electrical power from the stack modules 212 during operation. The electronic infrastructure also includes an energy supply management system 214, for monitoring and controlling operation of the energy supply system 200 and to provide integration of the energy supply system 200 with the electronic infrastructure of the aircraft 100.

The stack modules 212 function to convert chemical energy into electrical energy for supply to the propulsion systems 108. Stack modules 212 can be arranged and/or distributed about the aircraft in any suitable manner. Fuel cell stacks can be arranged within wings (e.g., inside of an airfoil cavity), inside nacelles, and/or in any other suitable location on the aircraft.

The fluid circulation system 208 functions to transfer heat from or to various components of the aircraft 100, for example by circulating a working fluid within a stack module 212 to remove heat generated during operation, to provide heat for evaporation of liquid hydrogen from the liquid hydrogen tank 120, or to remove heat from other heat-generating components within the aircraft 100.

It is to be understood that the energy supply system 200 can, in other examples, analogously be implemented with alternative types of architectures, such as a hybrid fuel-cell powertrain architecture including electric batteries.

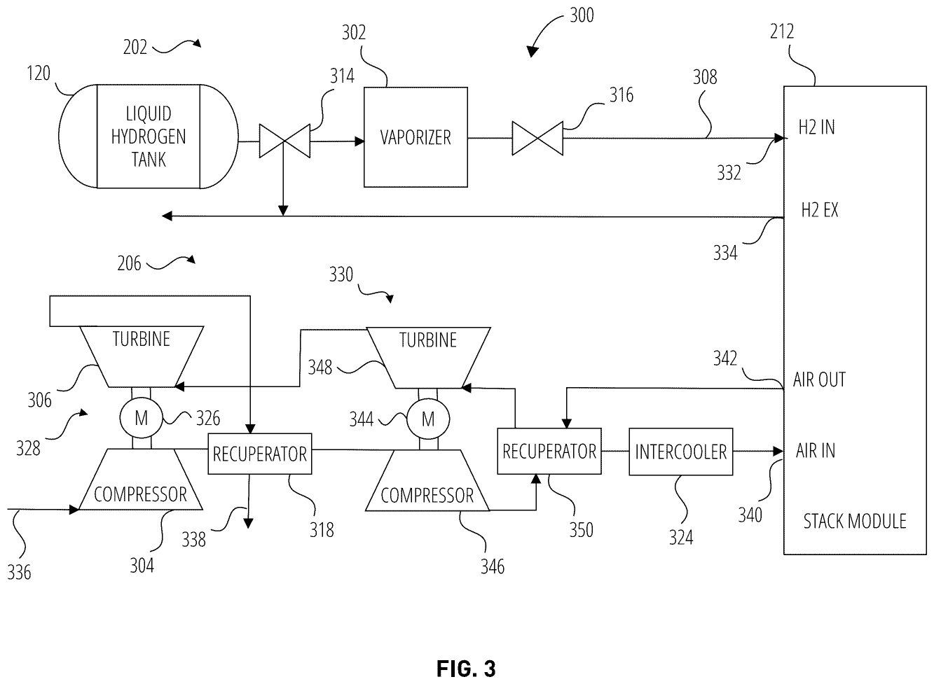

FIG. 3 is a schematic diagram illustrating a hydrogen and air supply system 300 for use in supplying a stack module 212 of the fuel cell stack of the aircraft of FIG. 1, according to some examples. The hydrogen and air supply system 300 includes an interconnected hydrogen supply system 202 and an air supply system 206. The hydrogen supply system 202 comprises a liquid hydrogen tank 120, a vaporizer 302, and associated valves and supply lines. The air supply system 206 includes a combined medium-pressure turbine and compressor 328, a combined high-pressure turbine and compressor 330, an intercooler 324, recuperators 318, recuperator 350, and associated valves and supply lines. The medium-pressure turbine and compressor 328 receives ambient air from a cathode air intake 336 and returns cathode exhaust air to the ambient environment, after passing through the recuperator 318, via an exhaust 338.

The liquid hydrogen tank 120, as its name suggests, stores liquid hydrogen for use in the stack module 212. The liquid hydrogen tank 120 is connected to, and supplies liquid hydrogen to the vaporizer 302. The vaporizer 302 includes a pump that pressurizes the liquid hydrogen and a heat exchanger that evaporates and expands the liquid hydrogen to approximately the temperature required by the stack module 212, and to a pressure above that required by the stack module 212. Hydrogen gas leaving the vaporizer 302 is provided to the hydrogen inlet 332 of the stack module 212 via supply line 308 via a valve 316. The valve 316 serves to regulate the pressure of the hydrogen gas supplied to the stack module 212 to a nominal fuel cell supply pressure.

Also provided in the supply line 308 from the liquid hydrogen tank 120 to the vaporizer 302 is a purge valve 314, which serves to release pressure generated in the liquid hydrogen tank 120 due to evaporation of the hydrogen in the liquid hydrogen tank 120. Excess hydrogen purged by the purge valve 314 from the liquid hydrogen tank 120 is routed to a hydrogen exhaust 334.

The medium-pressure turbine and compressor 328 includes a compressor 304, a turbine 306 and a motor 326. The compressor 304 compresses air received at a cathode air intake 336, after it has been filtered. The compressed air leaving the compressor 304 passes through the recuperator 318, where it loses heat, and is then passed to the high-pressure turbine and compressor 330.

The high-pressure turbine and compressor 330 includes a compressor 346, a turbine 348 and a motor 344. The compressor 346 further compresses the air received from the compressor 304 and the recuperator 318. The compressed air leaving the compressor 346 passes through the recuperator 350, where is cooled by exchanging heat with the cathode exhaust air leaving the stack module 212 via the cathode air exhaust outlet 342. Compressed air leaving the recuperator 350 is then cooled by coolant in the intercooler 324 before being provided to the stack module 212.

Exhaust air leaves the stack module 212 via the cathode air exhaust outlet 342. The exhaust air is routed to the recuperator 318 where it receives heat from the air compressed by the compressor 346. The exhaust air leaving the recuperator 350 is used to drive the turbine 348 of the high-pressure turbine and compressor 330.

The turbine 348 in the high-pressure turbine and compressor 330 is driven by the pressure differential between the air leaving the recuperator 350 and the air supplied to the turbine 306. The turbine 348 assists the motor 344 in driving the compressor 346, which compresses the inlet air as discussed above. The turbine 348 thus decreases the amount of work done by the motor 344 in compressing the inlet air, increasing the overall efficiency of the energy supply system 200.

The turbine 306 in the medium-pressure turbine and compressor 328 is in turn driven by the pressure differential between the air leaving the turbine 348 and the exhaust air supplied to recuperator 318. The turbine 306 assists the motor 326 in driving the compressor 304, which compresses the inlet air as discussed above. The turbine 306 thus decreases the amount of work done by the motor 326 in compressing the inlet air, increasing the overall efficiency of the energy supply system 200.

The recuperators 318, 350 can take various forms. These can be direct heat exchangers or indirect heat exchangers using an intermediary heat exchange fluid like coolant or refrigerant.

The turbines 306, 348 can alternatively be any other type of expansion engine that can be used to convert a pressure differential in a gas into work, such as for example a piston engine. Similarly, the compressor 304 can alternatively be any other mechanical device that can extract work from operation of the expansion engine, such as a dynamo or generator.

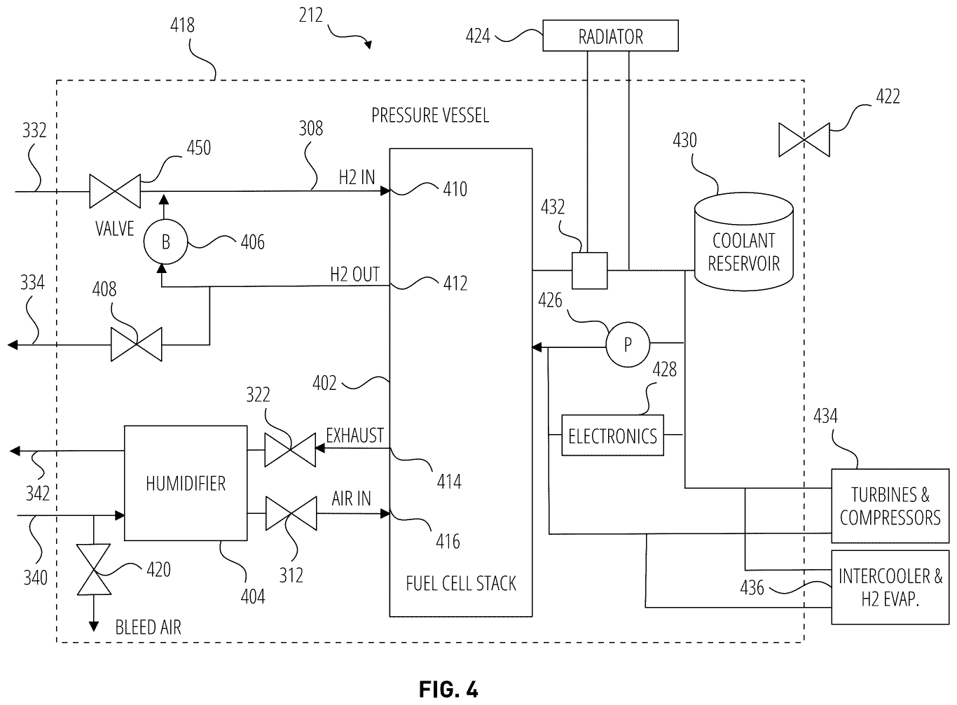

FIG. 4 is a schematic diagram illustrating a stack module 212 of the fuel cell stack of the aircraft 100 of FIG. 1, according to some examples. The stack module 212, which is coupled to a radiator 424, includes a fuel cell stack 402, a humidifier 404, a coolant reservoir 430 and various pumps and valves. The stack module 212 is enclosed by a pressure vessel 418. Although not strictly part of the stack module 212, also enclosed in the pressure vessel 418 are power electronics 428.

Inlet air, which is generally dry at altitude, that is received from the intercooler 324 is humidified by the humidifier 404 before passing into the fuel cell stack 402 via the air inlet 416. Control of the flow of air into the fuel cell stack 402 is accomplished by means of a valve 312. Exhaust air from the fuel cell stack 402 leaves via exhaust 414 and passes into the humidifier 404, which includes a membrane that allows water vapor from the exhaust to pass through it to the inlet air. Control of the flow of exhaust leaving the fuel cell stack 402 is accomplished by means of a valve 322.

A bleed air valve 420 is provided between the air inlet 340 and the humidifier 404. The bleed air valve 420 is located inside the pressure vessel 418, and maintains the air pressure in the pressure vessel 418 at the required pressure by supplying compressed air from the air supply system 206 received via air inlet 340. In some examples, the air pressure in the valve 408 is maintained at an air pressure of approximately 1 atmosphere, or a specified pressure between ambient pressure and the air pressure at air inlet 340. In other examples, the bleed air valve 420 is provided between the humidifier 404 and air exhaust outlet 342.

The pressure vessel 418 is also provided with a purge valve 422, which is coupled to an outlet to the external atmosphere outside the aircraft 100. In some examples, the purge valve 422 is used instead of or in conjunction with the bleed air valve 420 to maintain the required pressure in the pressure vessel 418. Leakages from within the stack module 212 will cause the pressure in the pressure vessel 418 to increase, which can then be relieved by the purge valve 422 under appropriate control by the energy supply management system 214 based on the desired absolute pressure in the pressure vessel 418 and the current ambient air pressure outside the aircraft 100.

In some examples, the pressure inside the pressure vessel is maintained by bleed air valve 420 and/or the purge valve 422 within a predetermined pressure range. The particular pressure range will be a matter of design choice and selected to provide one or more of the benefits described herein. In some examples, the predetermined pressure range is from 0.5 atmospheres to 2 atmospheres. In other examples, the lower level is from 0.75, 0.9 or 1 atmosphere and the upper level is to 1, 1.25, 1.5 or 1.75 atmospheres. The air pressure in the pressure vessel is generally greater than or equal to the air pressure in the surrounding environment, particularly in flight.

In other examples, the pressure inside the pressure vessel is maintained between +0.5 bar (gauge) and −2 bar (gauge) of the pressure within the fuel cell.

The purge valve 422 can also be used to purge the pressure vessel 418 in the event that hydrogen levels inside the pressure vessel 418, as determined by hydrogen sensors located in the pressure vessel 418, exceed a threshold beyond which the concentration of hydrogen in the pressure vessel 418 is unacceptable. In such a case, fresh air is provided by the bleed air valve 420, which will also continue to maintain the required pressure in the pressure vessel 418 during any required purging.

The hydrogen inlet 410 of the fuel cell stack 402 is supplied with hydrogen via valve 450, which is fed from supply line 308 from the hydrogen inlet 332 to the stack module 212. Hydrogen exhaust leaving the fuel cell stack 402 via hydrogen exhaust 412 is either returned to the supply line 308 via a hydrogen recirculation loop including a hydrogen blower 406, or is purged as appropriate via valve 408 to the hydrogen exhaust 334.

The fuel cell stack 402, the electronics 428, the turbines & compressors 434 (comprising high-pressure turbine and compressor 330 and medium-pressure turbine and compressor 328), and the intercooler & H2 vaporizer 436 (comprising the intercooler 324 and vaporizer 302) are cooled by a coolant circulation loops that includes a coolant pump 426, a radiator 424 and a coolant reservoir 430.

Coolant circulated in the coolant loops by the coolant pump 426 is selectively routed to the radiator 424 by the three-way valve 432 depending on the amount of cooling that is required.

The number of components enclosed in the pressure vessel 418, as can the number of pressure vessels used. In one example, all of the components of the hydrogen and air supply system 300 and the stack module 212, including the electronics 428, are enclosed in a pressure vessel except for the liquid hydrogen tank 120 and the radiator 424, which is exposed to external air. In some examples, more than one pressure vessel may be provided, with for example the electronics 428 having its own pressure vessel.

By enclosing relevant components in one or more pressure vessels in this manner, and maintaining their pressure as described, one or more of the problems associated with high altitude operation can be alleviated. A constant and appropriate gage pressure is maintained for the fuel cell stacks, improving efficiency, electrical components used at ground level can be selected, or electrical components design considerations can be adjusted to take into account the more favorable operating environment, and the functioning of the cooling loop is improved, particularly as regards the coolant contained in the coolant reservoir 430.

Additionally, by containing the fuel cell stack 402 in a separate pressure vessel 418 with a dedicated purge valve 422 to the external environment, aircraft safety is further improved by containing and appropriately ventilating any hydrogen that leaks from systems within stack module 212.

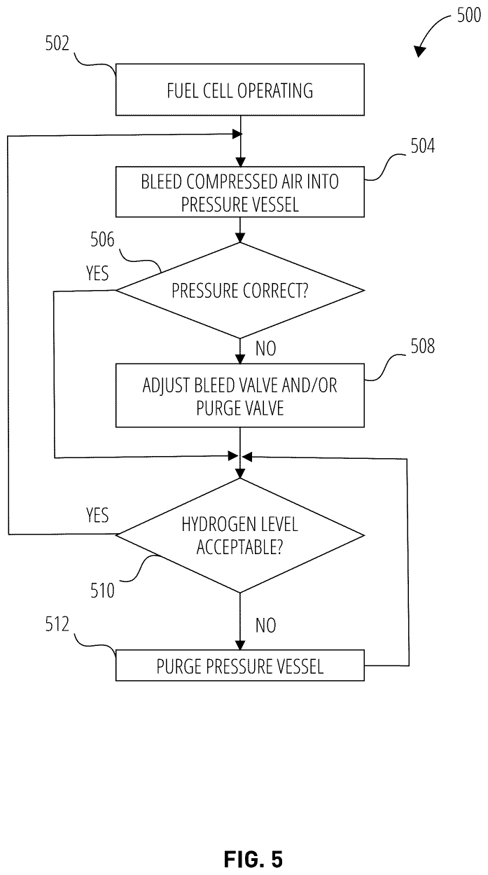

FIG. 5 is a flowchart 500 illustrating operation of the energy supply system 200 according to some examples. For explanatory purposes, the operations of the flowchart 500 are described herein as occurring in serial, or linearly. However, multiple operations of the flowcharts may occur in parallel. In addition, the operations of the flowcharts need not be performed in the order shown and/or one or more blocks of the flowcharts need not be performed and/or can be replaced by other operations. The operations of the flowcharts may be performed by various components of the energy supply system 200 under control of the energy supply management system 214, or by related systems and processors.

The flowchart 500 commences at operation 502, in which the fuel cell 204 is operating. In operation 504, compressed air is bled into the pressure vessel enclosing the particular components by the bleed air valve 420, which is open to an appropriate degree. In operation 506, the energy supply management system 214 determines whether the pressure in the pressure vessel is at an appropriate level based on output received from one or more pressure sensors located in the pressure vessel 418. That is, whether the pressure is within a predetermined pressure range or at a particular pressure level within an associated tolerance. If the pressure is at an appropriate level, the flowchart 500 proceeds to operation 510. If the pressure is not acceptable, the bleed air valve 420 and/or the purge valve 422 are adjusted in operation 508 to increase or decrease the pressure in the pressure vessel 418, as appropriate.

In some examples, the degree of opening of the bleed air valve 420 is increased by the energy supply management system 214 to increase the pressure in the pressure vessel 418 in response to the pressure being below a lower threshold, and the degree of opening of the bleed air valve 420 is decreased to decrease the pressure in the pressure vessel 418 in response to the pressure being above an upper threshold.

Alternatively or in addition, if the pressure is below a lower threshold, then a degree of opening of the purge valve 422 can be reduced, or it can be completely closed by the energy supply management system 214, until the pressure in the pressure vessel 418 meets the pressure requirements, at which point the purge valve 422 is opened further by the energy supply management system 214 to bleed off any excess pressure to the external environment. Similarly, a degree of opening of the purge valve 422 can be increased in response to the pressure being above an upper threshold.

The purge valve 422 and the bleed air valve 420 are thus operated separately or in tandem to maintain the pressure in the pressure vessel 418 between upper and lower limits.

At operation 510, the energy supply management system 214 determines whether or not the level of hydrogen in the pressure vessel is acceptable using data received from hydrogen sensors located in the pressure vessel 418. If the level of hydrogen in the pressure vessel 418 is acceptable, the flowchart 500 returns to operation 504 and proceeds from there. If the hydrogen level in the pressure vessel 418 has exceeded a threshold level, the energy supply management system 214 purges the pressure vessel by opening purge valve 422 in operation 512, until the hydrogen level becomes acceptable again, as determined in operation 510. In some examples, the degree of opening of the bleed air valve 420 is increased during purging of the pressure vessel 418, to assist the purging and to maintain the required pressure level in the pressure vessel 418 during purging. After the hydrogen level has returned to an acceptable level as determined in operation 510, flowchart 500 returns to operation 504 and proceeds from there.

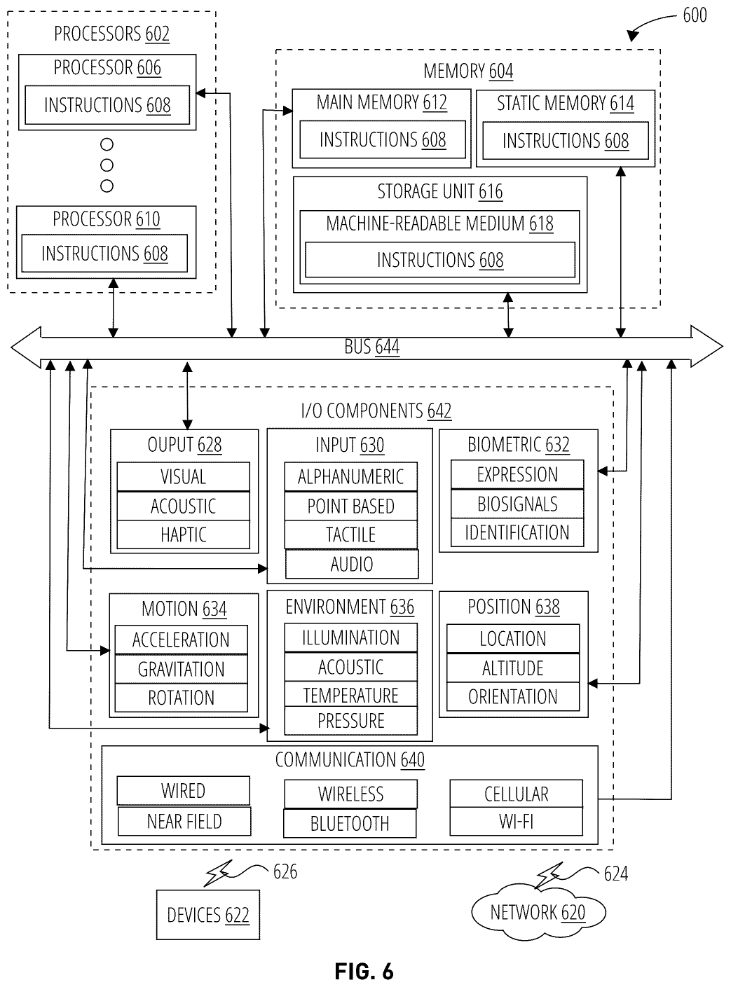

FIG. 6 illustrates a diagrammatic representation of a machine 600 in the form of a computer system within which a set of instructions may be executed for causing the machine to perform any one or more of the methodologies discussed herein, such as the energy supply management system 214 according to some examples. Specifically, FIG. 6 shows a diagrammatic representation of the machine 600 in the example form of a computer system, within which instructions 608 (e.g., software, a program, an application, an applet, an app, or other executable code) for causing the machine 600 to perform any one or more of the methodologies discussed herein may be executed. The instructions 608 transform the general, non-programmed machine 600 into a particular machine 600 programmed to carry out the described and illustrated functions in the manner described. In alternative examples, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines 600 that individually or jointly execute the instructions 608 to perform any one or more of the methodologies discussed herein.

The machine 600 may include processors 602, memory 604, and I/O components 642, which may be configured to communicate with each other such as via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that may execute the instructions 608. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 may include a main memory 612, a static memory 614, and a storage unit 616, both accessible to the processors 602 such as via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the processors 602 (e.g., within the processor's cache memory), or any suitable combination thereof, during execution thereof by the machine 600.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones will likely include a touch input device or other such input mechanisms, while a headless server machine will likely not include such a touch input device. It will be appreciated that the I/O components 642 may include many other components that are not shown in FIG. 6. The I/O components 642 are grouped according to functionality merely for simplifying the following discussion and the grouping is in no way limiting. In various examples, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 642 may include biometric components 632, motion components 634, environmental components 636, or position components 638, among a wide array of other components. For example, the biometric components 632 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 may include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 604, main memory 612, static memory 614, and/or memory of the processors 602) and/or storage unit 616 may store one or more sets of instructions and data structures (e.g., software) embodying or utilized by any one or more of the methodologies or functions described herein. These instructions (e.g., the instructions 608), when executed by processors 602, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 620 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 620 or a portion of the network 620 may include a wireless or cellular network, and the coupling 624 may be a Code Division Multiple Access (CDMA) connection, a Global System for Mobile communications (GSM) connection, or another type of cellular or wireless coupling. In this example, the coupling 624 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 608 may be transmitted or received over the network 620 using a transmission medium via a network interface device (e.g., a network interface component included in the communication components 640) and utilizing any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 608 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Various examples are contemplated. Example 1 is a fuel cell system, comprising: a pressure vessel; a fuel cell stack located in the pressure vessel; a source of compressed air to provide air to the fuel cell stack; and one or more valves to maintain the pressure inside the pressure vessel within a predetermined pressure range.

In Example 2, the subject matter of Example 1 includes, wherein the one or more valves supply compressed air from the source of compressed air into the pressure vessel.

In Example 3, the subject matter of Examples 1-2 includes, wherein the one or more valves are operable to vent excess pressure in the pressure vessel to the external environment.

In Example 4, the subject matter of Example 3 includes, a hydrogen level sensor located in the pressure vessel; and a control system operable to open the one or more valves to purge the pressure vessel based on the level of hydrogen in the pressure vessel, as reported by the hydrogen level sensor, exceeding a threshold value.

In Example 5, the subject matter of Examples 1-4 includes, a coolant loop coupled to the fuel cell stack and operable to cool the fuel cell stack, the coolant loop including a reservoir located in the pressure vessel.

In Example 6, the subject matter of Examples 1-5 includes, power electronics located inside the pressure vessel.

In Example 7, the subject matter of Examples 1-6 includes, wherein the one or more valves comprise a purge valve coupled to an external environment and operable to purge the pressure vessel, the fuel cell system further comprising: a hydrogen level sensor located in the pressure vessel; and a control system to open the purge valve to purge the pressure vessel based on the level of hydrogen in the pressure vessel, as reported by the hydrogen level sensor, exceeding a threshold value.

In Example 8, the subject matter of Example 7 includes, power electronics located inside the pressure vessel.

Example 9 is a method of operating an aircraft including a fuel cell system having a fuel cell stack located in a pressure vessel, the method comprising: flying the aircraft; and maintaining the pressure inside the pressure vessel containing the fuel cell stack within a predetermined pressure range.

In Example 10, the subject matter of Example 9 includes, wherein maintaining the pressure inside the pressure vessel containing the fuel cell stack comprises providing air into the pressure vessel from a source of compressed air for the fuel cell stack.

In Example 11, the subject matter of Examples 9-10 includes, wherein maintaining the pressure inside the pressure vessel containing the fuel cell stack comprises purging air from the pressure vessel into the external environment.

In Example 12, the subject matter of Examples 9-11 includes, purging the pressure vessel based on a level of hydrogen in the pressure vessel exceeding a threshold value.

In Example 13, the subject matter of Examples 9-12 includes, monitoring a level of hydrogen in the pressure vessel: detecting that the level of hydrogen in the pressure vessel has exceeded a threshold; and based on detecting that the level of hydrogen in the pressure vessel has exceeded a threshold, purging the pressure vessel.

Example 14 is a non-transitory machine-readable medium including instructions which, when read by a machine, cause the machine to perform operations in an aircraft including a fuel cell system having a fuel cell stack located in a pressure vessel, the operations comprising: operating the fuel cell system to generate power for the aircraft; and maintaining the pressure inside the pressure vessel within a predetermined pressure range.

In Example 15, the subject matter of Example 14 includes, wherein the operations further comprise: monitoring a level of hydrogen in the pressure vessel during flight: detecting that the level of hydrogen in the pressure vessel has exceeded a threshold; and purging the pressure vessel based on detecting that the level of hydrogen has exceeded the threshold.

In Example 16, the subject matter of Examples 14-15 includes, wherein maintaining the pressure inside the pressure vessel containing the fuel cell stack comprises providing air into the pressure vessel from a source of compressed air for the fuel cell stack.

In Example 17, the subject matter of Examples 14-16 includes, wherein maintaining the pressure inside the pressure vessel containing the fuel cell stack comprises purging air from the pressure vessel into the external environment.

In Example 18, the subject matter of Example 17 includes, wherein maintaining the pressure inside the pressure vessel containing the fuel cell stack comprises providing air into the pressure vessel from a source of compressed air for the fuel cell stack.

In Example 19, the subject matter of Examples 15-18 includes, wherein the operations further comprise: purging the pressure vessel based on a level of hydrogen in the pressure vessel exceeding a threshold value.

In Example 20, the subject matter of Examples 15-19 includes, wherein maintaining the pressure inside the pressure vessel within a predetermined pressure range comprises: supplying compressed air from a source of compressed air that provides air to the fuel cell stack into the pressure vessel using a valve.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20. Example 23 is a system to implement of any of Examples 1-20. Example 24 is a method to implement of any of Examples 1-20.

Examples of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the examples of the invention disclosed herein without departing from the scope of this invention defined in the following claims.

What is claimed is:

1. A fuel cell system, comprising:
a pressure vessel;
a fuel cell stack located in the pressure vessel;
a source of compressed air to provide air to the fuel cell stack; and
one or more valves to maintain the pressure inside the pressure vessel within a predetermined pressure range.

2. The fuel cell system of claim 1, wherein the one or more valves supply compressed air from the source of compressed air into the pressure vessel.

3. The fuel cell system of claim 1, wherein the one or more valves are operable to vent excess pressure in the pressure vessel to the external environment.

4. The fuel cell system of claim 3, further comprising:
a hydrogen level sensor located in the pressure vessel; and
a control system operable to open the one or more valves to purge the pressure vessel based on the level of hydrogen in the pressure vessel, as reported by the hydrogen level sensor, exceeding a threshold value.

5. The fuel cell system of claim 1, further comprising a coolant loop coupled to the fuel cell stack and operable to cool the fuel cell stack, the coolant loop including a reservoir located in the pressure vessel.

6. The fuel cell system of claim 1, further comprising power electronics located inside the pressure vessel.

7. The fuel cell system of claim 1, wherein the one or more valves comprise a purge valve coupled to an external environment and operable to purge the pressure vessel, the fuel cell system further comprising:
a hydrogen level sensor located in the pressure vessel; and
a control system to open the purge valve to purge the pressure vessel based on the level of hydrogen in the pressure vessel, as reported by the hydrogen level sensor, exceeding a threshold value.

8. The fuel cell system of claim 7, further comprising power electronics located inside the pressure vessel.

9. A method of operating an aircraft including a fuel cell system having a fuel cell stack located in a pressure vessel, the method comprising:
flying the aircraft; and
maintaining the pressure inside the pressure vessel containing the fuel cell stack within a predetermined pressure range.

10. The method of claim 9, wherein maintaining the pressure inside the pressure vessel containing the fuel cell stack comprises providing air into the pressure vessel from a source of compressed air for the fuel cell stack.

11. The method of claim 9, wherein maintaining the pressure inside the pressure vessel containing the fuel cell stack comprises purging air from the pressure vessel into the external environment.

12. The method of claim 9, further comprising:
purging the pressure vessel based on a level of hydrogen in the pressure vessel exceeding a threshold value.

13. The method of claim 9, further comprising:
monitoring a level of hydrogen in the pressure vessel:
detecting that the level of hydrogen in the pressure vessel has exceeded a threshold; and
based on detecting that the level of hydrogen in the pressure vessel has exceeded a threshold, purging the pressure vessel.

14. A non-transitory machine-readable medium including instructions which, when read by a machine, cause the machine to perform operations in an aircraft including a fuel cell system having a fuel cell stack located in a pressure vessel, the operations comprising:
operating the fuel cell system to generate power for the aircraft; and
maintaining the pressure inside the pressure vessel within a predetermined pressure range.

15. The non-transitory machine-readable medium of claim 14, wherein the operations further comprise:
monitoring a level of hydrogen in the pressure vessel during flight:
detecting that the level of hydrogen in the pressure vessel has exceeded a threshold; and
purging the pressure vessel based on detecting that the level of hydrogen has exceeded the threshold.

16. The non-transitory machine-readable medium of claim 14, wherein maintaining the pressure inside the pressure vessel containing the fuel cell stack comprises providing air into the pressure vessel from a source of compressed air for the fuel cell stack.

17. The non-transitory machine-readable medium of claim 14, wherein maintaining the pressure inside the pressure vessel containing the fuel cell stack comprises purging air from the pressure vessel into the external environment.

18. The non-transitory machine-readable medium of claim 17, wherein maintaining the pressure inside the pressure vessel containing the fuel cell stack comprises providing air into the pressure vessel from a source of compressed air for the fuel cell stack.

19. The non-transitory machine-readable medium of claim 15, wherein the operations further comprise:
purging the pressure vessel based on a level of hydrogen in the pressure vessel exceeding a threshold value.

20. The non-transitory machine-readable medium of claim 15, wherein maintaining the pressure inside the pressure vessel within a predetermined pressure range comprises:
supplying compressed air from a source of compressed air that provides air to the fuel cell stack into the pressure vessel using a valve.
